(19) United States
(12) Patent Application Publication
(10) Pub. No.: US 2011/0031713 A1
(43) Pub. Date: Feb. 10, 2011

(54) ROD END MOUNTING BUSHING

(76) Inventor: Michael W. Ekbundit, Mt. Washington, KY (US)

Correspondence Address: Woodard, Emhardt, Moriarty, McNett & Henry LLP, 111 Monument Circle, Suite 3700, Indianapolis, IN, 46204-5137, US

(21) Appl. No.: 12/535,095

(22) Filed: Aug. 4, 2009

(51) Int. Cl. B60G 9/02; B23P 11/00; F16C 31/02; F16C 11/00; F16D 1/00; B60G 7/02

(52) U.S. Cl. 280/124.121; 29/525.01; 16/2.2; 403/65; 403/408.1; 280/86.757

(57) ABSTRACT

A rod end mounting bushing for use in a connection assembly is disclosed. The rod end mounting bushing has a generally cylindrical body with a longitudinal axis line extending through the body and opposite end faces wherein each end face has a defining geometric plane. Each geometric plane is constructed and arranged at an angle of incline relative to the longitudinal axis line of the generally cylindrical body. The body defines a through aperture which extends from one end face to the opposite end face. This through aperture has a longitudinal axis line which is substantially perpendicular to at least one of the end faces.

### BACKGROUND OF THE INVENTION

The current disclosure is directed to the design and construction of rod end mounting bushings and the use of a pair of such bushings as part of a rod end connection in a suspension linkage. In the exemplary embodiment which is disclosed, the rod end mounting bushings are used as a matched pair in cooperation with a spherical joint.

Spherical joints, such as on rod ends as a part of suspension linkages, are typically connected to a vehicle superstructure by the use of a clevis arrangement of two spaced-apart plates. While the two clevis plates are substantially parallel to each other, they are typically welded into position with an angle which is intended to generally correspond to the angle of the rod which is received between the two clevis plates. Considering the location for the two clevis plates and the confined working space, the welding task can be challenging and it may be difficult to (accurately) achieve the desired angle. If the two clevis plates are not set (i.e., welded in position) with an angle which is fairly close to the rod angle, proper alignment and proper installation become design and construction issues for the rod end assembly. Depending on the structural specifics and vehicle design, these design and construction issues can be significant. While there is some range of motion tolerance for the spherical joint, the greater the clevis plate misalignment, the more this range of motion tolerance is used up.

As used herein, the conventional X-axis direction corresponds to the longitudinal centerline of the vehicle which has the referenced suspension linkage and uses the disclosed rod end mounting bushings. The Y-axis direction is perpendicular to the X-axis direction and, as used herein, extends laterally through the vehicle from side to side. Accordingly, when describing that the two clevis plates are set at an angle, and similarly in describing the suspension linkage rod axis or longitudinal centerline being at an angle, this is a direction which is not parallel to either the X-axis direction or to the Y-axis direction, as those are defined herein.

In a heavy duty suspension application, the clevis connection typically consists of thick plates of steel, spaced apart, so as to receive the spherical joint therebetween. These thick plates do not bend when the securing bolt is tightened. Further, in any design modification, refurbishment, or reconstruction, these thick plates may warp during welding. The angular alignment issues and any warping problems can combine with the inability to bend, thereby making proper bolt hole alignment difficult. These factors are seen as the primary contributors in making proper installation/assembly of the spherical joint more difficult. Modification or reconstruction (refurbishment) work is made more time consuming when the thick plates are not properly aligned (hole alignment) and have to be further reworked, typically by on-site machining. As noted above, if the clevis plates are misaligned such that their angle does not closely correspond to the rod axis angle, some (or all) of the range of motion tolerance of the spherical joint can be used up.

If all of the cooperating structures are aligned within the desired tolerances, then the two clevis plates define a clearance space therebetween which receives the rod end (spherical joint) misalignment spacers, and mounting hardware (washers). Bolt holes in the clevis plates would also be generally aligned for receipt of the securing (shoulder) bolt which extends through the spherical joint.

One specific application where the thick plate alignment problem can be seen is as part of an axle suspension system of a military vehicle. Typically, the axle is supported from the frame by a four-bar linkage type of suspension including a V-shaped upper link. The apex of the upper link is secured to the frame above the axle by a spherical (ball) joint connection to permit limited universal movement of the upper link relative to the axle. Opposite ends of the upper link are connected to the referenced clevis connections which in turn are welded or otherwise attached to the superstructure of the vehicle.

The thick plate (clevis arrangement) alignment issue, as discussed above, is addressed by the present disclosure and by its exemplary embodiment by the use of rod end mounting bushings. A pair of mounting bushings is used with the assembly of each spherical joint (i.e., the rod end) as part of its overall connection to the pair of clevis plates or to another similar support structure. The disclosed mounting bushings permit use of a support structure in lieu of welding on clevis plates to that support structure. The disclosed rod end mounting bushings offer a simple and effective way to connect various rod ends to a superstructure, whether or not clevis plates are being used. If clevis plates are used for the rod end connection, the angular alignment of those plates relative to the rod axis is not as critical. In part this is why a portion of the vehicle superstructure can be used in lieu of using a pair of clevis plates. The various fabrication, design, and use options disclosed herein provide greater overall versatility in a more efficient and cost effective manner, one of the benefits of the disclosed mounting bushings.

### BRIEF SUMMARY

A rod end mounting bushing for use in a connection assembly is disclosed. The rod end mounting bushing has a generally cylindrical body with a longitudinal axis line extending through the body and with opposite end faces wherein each end face has a defining geometric plane. Each geometric plane is constructed and arranged at an angle of incline relative to the longitudinal axis line of the generally cylindrical body. The body defines a through aperture which extends from one end face to the opposite end face. This through aperture has a longitudinal axis line which is substantially perpendicular to at least one of the end faces.

One object of the present disclosure is to describe an improved rod end mounting bushing for use in a connection assembly.

### BRIEF DESCRIPTION OF THE SEVERAL VIEWS OF THE DRAWINGS

FIG. 1 a perspective view of a rod end connection assembly including a pair of rod end mounting bushings according to the present disclosure.

FIG. 2 is a partial, perspective view of a pair of clevis plates as welded to a vehicle superstructure.

FIG. 3 is a partial, perspective view of a vehicle superstructure providing a mounting platform for the FIG. 1 rod end connection assembly.

FIG. 4 is a fragmentary, front elevational view of a rod end mounting bushing according to the present disclosure.

FIG. 5 is a diagrammatic illustration of the FIG. 4 rod end mounting bushing oriented as in use in the FIG. 1 rod end connection assembly.

FIG. 5A is a diagrammatic illustration of the FIG. 5 illustration with additional geometric planes, axis lines, and included angles.

FIG. 5B is a diagrammatic illustration of the two bushings as facing each other with an angled clearance space therebetween.

FIG. 6 is a top plan view of the FIG. 4 rod end mounting bushing.

FIG. 7 is a front elevational view of an alternative rod end mounting bushing having a smaller included angle relative to the FIG. 4 construction.

FIG. 8 is a diagrammatic illustration of the FIG. 7 rod end mounting bushing as it would be installed in a rod end connection assembly, similar to FIG. 1.

FIG. 9 is a top plan view of the FIG. 7 rod end mounting bushing.

FIG. 10 is a partial, front elevational view, in full section, of the support structure which receives one FIG. 4 rod end mounting bushing.

FIG. 11 is a partial, front elevational view, in full section, of the support structure which receives one FIG. 7 rod end mounting bushing.

FIG. 12 is a fragmentary, front elevational view of a spacer comprising one portion of the FIG. 1 rod end connection assembly.

FIG. 13 is a top plan view of the FIG. 12 spacer.

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

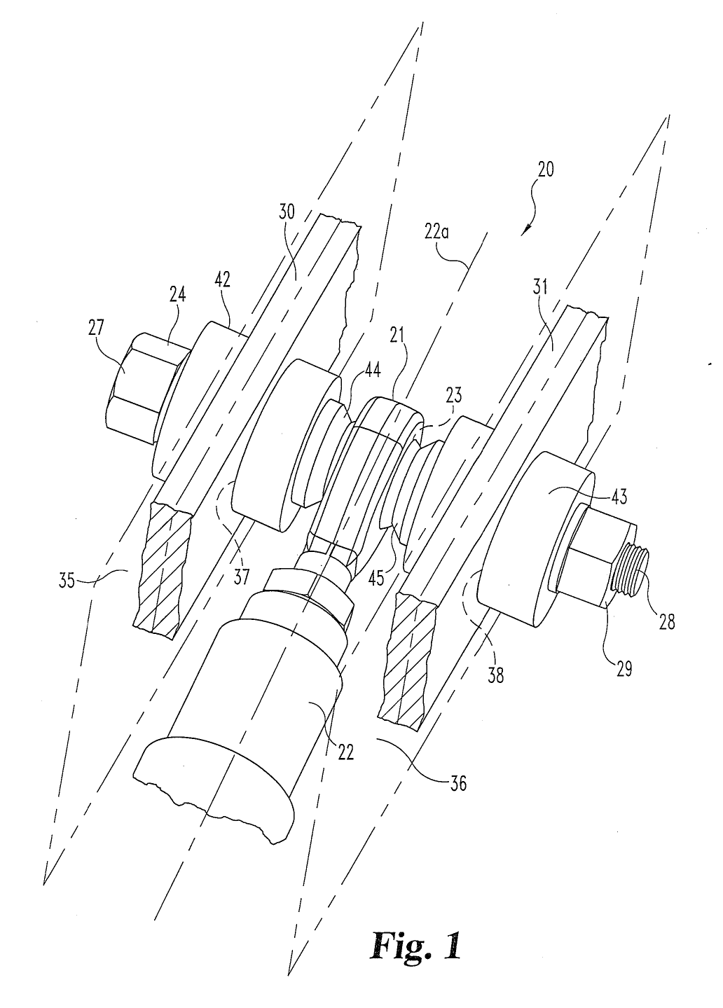

Referring to FIG. 1, there is illustrated a connection assembly 20 for a rod end 21 according to the present disclosure. In this exemplary embodiment, the illustrated rod 22 is a cylinder which is used as part of a suspension linkage for a vehicle. Rod 22 has a longitudinal centerline 22a which is typically at an angle relative to this X-axis and Y-axis of the vehicle, as defined herein. The rod end 21 is a spherical joint and defines an opening 23 for receipt of fastener 24. Fastener 24 can be of any suitable construction for securing the illustrated components together. Since a threaded body is not required for any of the interior components of connection assembly 20, in the exemplary embodiment, the illustrated fastener 24 is preferably a shoulder bolt which includes a hex head 27 and an externally threaded end 28. Threaded end 28 receives a securing hex nut 29. The plain body portion of shoulder bolt 24, which generally extends between hex head 27 and threaded end 28, is preferable for the type of surface-to-surface interfaces which exist as a part of connection assembly 20.

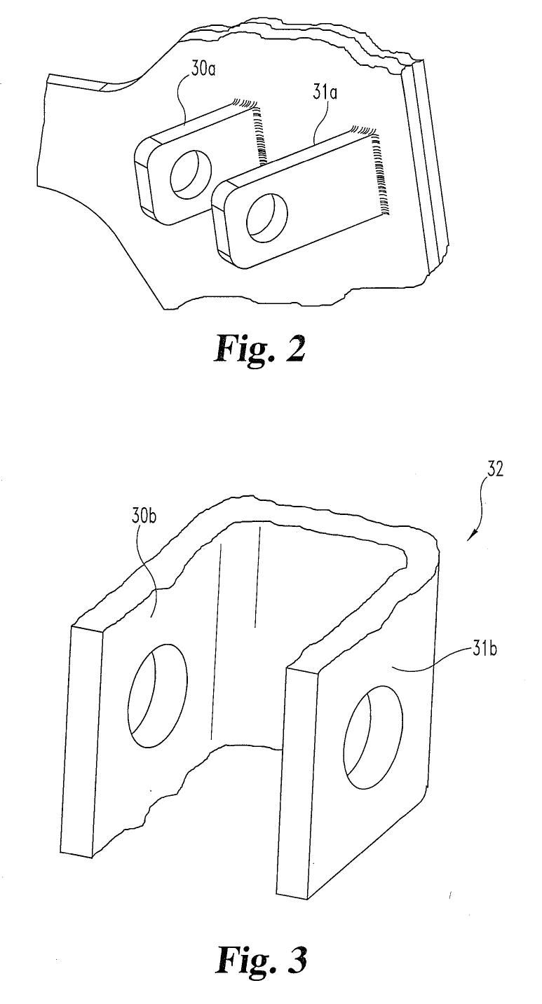

Although not actually “supplied” as part of the connection assembly 20, the two receiving members 30 and 31 typically have a clevis configuration and represent those portions of the structure (superstructure of the vehicle) to which the rod end 21 of the rod (suspension linkage) 22 is connected. A clearance aperture 37 and 38 in each receiving member 30 and 31, respectively, is provided for receipt of a rod end mounting bushing, as further described herein. These two spaced-apart receiving members 30 and 31 create a clevis plate structure as illustrated in FIG. 1. The FIG. 1 illustration for receiving members 30 and 31 is intended to be a representative or exemplary embodiment illustrating two structural support members which are spaced apart from each other a sufficient distance so as to provide a clearance space for receiving the stack up of the illustrated components. These representative support plates identified as receiving members 30 and 31 may be constructed and arranged as typical clevis plates, as illustrated in FIG. 2. Another option is to utilize some other support structure or superstructure 32 of the vehicle for these two receiving members, as is illustrated in FIG. 3. In the FIG. 2 illustration, these clevis members are identified as items 30a and 31a. Alternatively, in the FIG. 3 illustration, these clevis members or structural portions are identified as items 30b and 31b. Regardless of the specific size, shape, or location, the rod end mounting connection, as disclosed herein, utilizes two support members, identified herein as receiving members 30 and 31. A further point to be understood with regard to the two receiving members is that ideally these two members are substantially parallel to each other. Without the benefit of the disclosed mounting bushings 42 and 43, the two receiving members are preferably set at an angle which substantially coincides with (i.e., is parallel with) the axis or longitudinal centerline 22a of the rod. Centerline 22a is also set at an angle relative to the X-axis and to the Y-axis of the vehicle. However, it is difficult to weld these two members (clevis plates) in position with precisely the desired angle. Further, since superstructure portions of the vehicle would normally not be set at an angle, clevis plates would typically have to be added. Even if superstructure portions of the vehicle might be set at an angle, there is a limited or remote likelihood that this particular angle would coincide with the angle of the longitudinal centerline 22a.

The relevant point to be made regarding the two receiving members 30 and 31 is that they represent the structural support portion of the vehicle to which rod end 21 is connected, the connection is made and completed in the manner illustrated in FIG. 1, using the illustrated components. These two receiving members 30 and 31 are spaced apart and each one is constructed and arranged such that it lays within a corresponding, substantially flat, geometric plane 35 and 36, respectively. It is intended for these geometric planes 35 and 36 to be substantially parallel to each other. Without the benefit of the disclosed mounting or alignment bushings 42 and 43 as described herein, it is important for the two receiving members to be installed at an angle which coincides with the angle of the longitudinal centerline 22a. It should also be assumed that the two receiving members 30 and 31 are normally of uniform thickness with flat surfaces such that each would be generally centered within its corresponding geometric plane.

As explained in the Background, it is expected that there will be some degree of misalignment or warpage of the two clevis plates, such that the geometric planes may not be precisely parallel to each other. It is also likely that these geometric planes will not be set at the desired angle. This outcome, albeit perhaps in varying degrees, is expected, whether utilizing an extended clevis construction, as illustrated in FIG. 2, or a superstructure construction, as illustrated in FIG. 3.

Each receiving member 30 and 31 is constructed and arranged with a through aperture 37 and 38, respectively. Without the benefit of the disclosed alignment bushings 42 and 43, it is important to try and have apertures 37 and 38 in some reasonable degree of axial alignment for proper and efficient connection of the rod end 21 and the passage of shoulder bolt 24. However, by using the pair of alignment bushings 42 and 43, the through apertures 37 and 38 are intentionally not constructed and arranged to be coaxial. Instead, the axes of these through apertures 37 and 38 are shifted along a common horizontal line relative to one another so as to purposefully create an angled or skewed alignment. The amount of aperture offset between the axes of apertures 37 and 38 helps to determine the gap between the facing surfaces of the alignment bushings 42 and 43 when the connection is fully assembled. As would be understood, each through aperture 37 and 38 has a defining axis line and while those axis lines are “aligned” in that they are on the same horizontal plane, they are shifted relative to one another by a distance which is determined in part by the angle of the longitudinal centerline 22a. The use of the pair of alignment bushings 42 and 43 also affords greater versatility in terms of the degree of parallelism of the receiving members 30 and 31 which is required and the degree of coincidence with the angle of the longitudinal centerline 22a relative to the X-axis and to the Y-axis of the vehicle.

There are a number of factors which affect the ability to precisely machine apertures 37 and 38 into corresponding receiving members 30 and 31, respectively. One consideration is whether the machining of the apertures 37 and 38 will be performed prior to assembly of the two receiving members to the vehicle superstructure. Machining the two apertures in the receiving members prior to welding the receiving members to the superstructure allows more accurate initial machining. However, some degree of alignment is later lost due to the warpage which results from the welding step. Machining the apertures 37 and 38 into the corresponding receiving members prior to assembly is also the most efficient from a machining perspective. An alternative is to machine the apertures 37 and 38 into the receiving members after assembly of the receiving members (welding) to the vehicle superstructure. While any warpage issue due to welding may be minimized by this approach, the size of the receiving members, the materials which are used, and the overall environment (an issue of clearance and accessibility) provide additional difficulties limiting one's ability to precisely machine these apertures 37 and 38 with the necessary axial alignment. While it may be possible to do so, time and cost are issues. The time which it takes to perform this machining step after assembly, and the resultant cost, are considered disadvantages.

The concerns regarding the size, location, and alignment of apertures 37 and 38 takes on a high priority for connection assemblies which do not have the benefit of using alignment bushings 42 and 43. When alignment bushings 42 and 43 are used as a part of the rod end connection, as described herein, there is a type of “self-alignment” which takes place. One design reality from the use of alignment bushings 42 and 43 is that apertures 37 and 38 do not have to be located quite as accurately or precisely if they are slightly oversized. The primary design consideration is ensuring that the axial centerlines or bore axes of apertures 37 and 38 are offset from each other the appropriate amount to allow the rod end 21 to be clamped. This clamping is performed by the combination of alignment bushings 42 and 43 (their inwardly directed faces) and (if used) spacers 44 and 45. If spacers 44 and 45 are not used in the connection assembly, then the clamping up against the rod end 21 is by only the two bushings 42 and 43 (using the associated connection hardware).

Although the FIG. 3 construction should eliminate any warpage issues due to welding, there are still concerns over structural alignment since the superstructure portion of the vehicle may have experienced its own wear and misalignment, simply due to use. This location also presents a number of challenges for the machining of the two apertures considering the size, materials, and environment (an issue of clearance and accessibility). Even if the superstructure portion can be used, the receiving apertures must be drilled or machined by hand and, as a result, acceptable axial alignment is difficult to achieve. For those connection assemblies which do not use the two alignment bushings 42 and 43, this is a significant concern. Perhaps a greater concern with trying to use a portion of the vehicle superstructure without using the two alignment bushings 42 and 43 is the failure to have the desired angle. These “concerns” tend to be non-issues when the alignment bushings are used.

Regardless of the approach selected for receiving members 30 and 31, when the alignment bushings 42 and 43 are used as disclosed herein, some degree of axial “misalignment” of the two through apertures 37 and 38 is required. The use of “misalignment” is intended to indicate that the axial centerlines of apertures 37 and 38 are not coaxial. However, when alignment bushings 42 and 43 are used, this lack of alignment is intentional. Not only is the non-alignment of centerlines intentional, the extent or degree of shift is selected based in part on the angularity of rod centerline 22a. Without the use and benefit of alignment bushings 42 and 43, the overall alignment concerns for the rod end connection are further complicated when the receiving members 30 and 31 (i.e., the clevis plates) must be installed at an angle. As described herein, it is anticipated that there will be alignment issues and problems relating to prior art rod end connections. Connection assembly 20 fully addresses those issues and problems. As such, the use of connection assembly 20 enables the proper installation of rod end 21 to the structural receiving members 30 and 31. This is accomplished without the need to spend additional time or incur additional costs in reworking of the receiving members 30 and 31. Connection assembly 20 is fully applicable to the FIG. 2 style and to the FIG. 3 style.

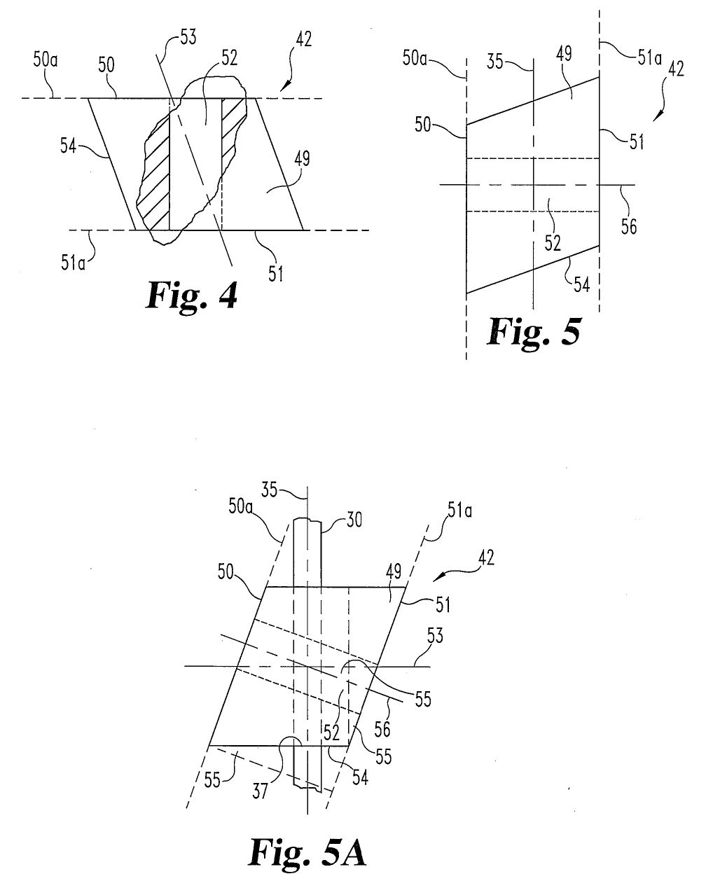

The connection assembly 20 includes fastener 24, the two alignment or rod end mounting bushings 42 and 43 (see FIGS. 4-6) and the two spacers 44 and 45 (see FIGS. 12 and 13). Bushing 42 is illustrated in FIGS. 4-6 and it is to be understood that bushing 43 is the same. Similarly, spacer 44 is illustrated in FIGS. 12 and 13 and spacer 45 is the same. As described herein, these two mounting bushings also can be thought of as “link cams” due in part to their eccentric construction. Optionally, flat washers and lock washers can be used in association with the hex head 27 (between head hex 27 and bushing 42) and in association with hex nut 29 (between hex nut 29 and bushing 43). Each spacer 44 and 45 provides a suitable contact surface for smooth movement of the spherical joint within rod end 21 and these spacers allow more motion in the spherical joint of the rod end 21. The smaller face 46 of each spacer 44 and 45 fits up against the inner race of the spherical joint for securely clamping all of the portions of connection assembly 20 together with the rod end and the receiving members. The tapered construction provides and defines the smaller face 46. This is important such that movement of rod end 21 does not result in any rubbing or friction up against any stationary surfaces. If these two spacers 44 and 45 are not used, the bushings 42 and 43 clamp onto the rod end 21.

As noted, each rod end mounting bushing 42 and 43 provides what could be called a “self-aligning” capability to connection assembly 20. This capability will be clear from the structural description of each bushing 42 and 43 which follows, combined with an understanding of the configuration of the receiving members 30 and 31 and the manner in which each through aperture 37 and 38 is machined into its corresponding receiving member 30 and 31. The disclosed mounting bushings 42 and 43 are suitable for use in the manner described relative to the FIG. 2 structure of receiving members 30a and 31a and relative to the FIG. 3 structure of receiving members 30b and 31b.

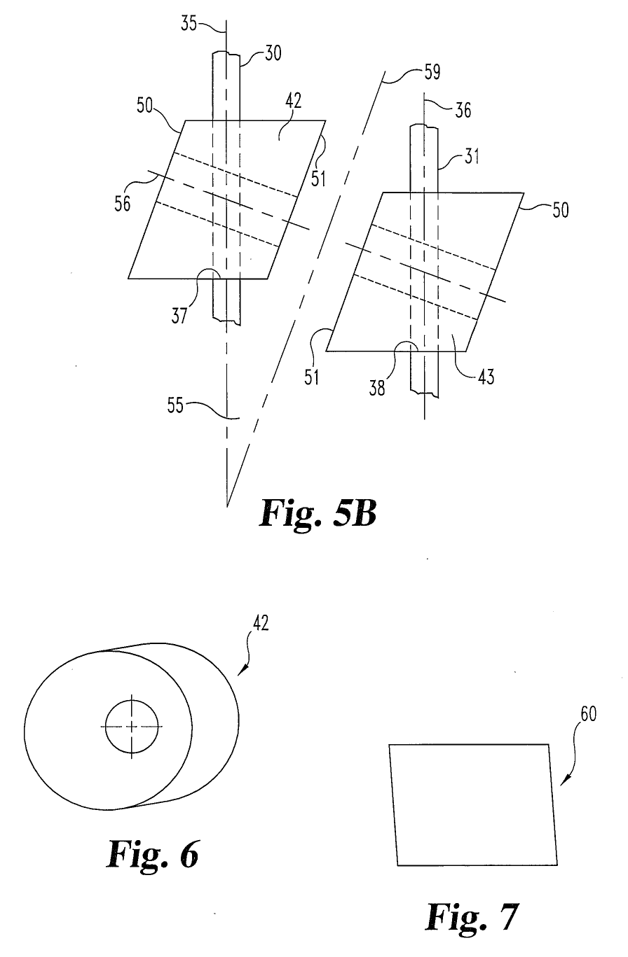

Referring to FIGS. 4, 5, 5A, and 6, one rod end mounting bushing 42 is illustrated. The FIG. 4 illustration provides an overall upright view of bushing 42. In the diagrammatic illustration of FIG. 5, bushing 42 is oriented as it would typically be used as is generally depicted in FIG. 1. In the diagrammatic illustration of FIG. 5A, geometric planes, axis lines, and included angles are identified. As illustrated, bushing 42 includes a generally cylindrical body 49, a pair of opposite end faces 50 and 51, and a through aperture 52, preferably a generally cylindrical bore which is defined by body 49. The longitudinal centerline 53 is positioned based on the outer surface 54 of body 49 and is substantially parallel with the outer surface 54 of body 49.

Each end face 50 and 51 is a substantially flat surface and defines a corresponding geometric plane 50a and 51a, respectively. The flat surfaces of the end faces 50 and 51 are substantially parallel to each other and are constructed and arranged with an angle of incline relative to the longitudinal centerline 53. In the FIG. 5A illustration, the angle of incline 55 (also noted as an included angle) is marked at various locations and the geometric relationships which are established should be clear, based on the shapes and structural information which has been provided. The axial centerline 56 of aperture 52 intersects the longitudinal centerline 53 at the same included angle of incline 55. This geometric relationship results due to the fact that the generally cylindrical aperture 52 is machined such that its axial centerline (axis) is perpendicular to each end face 50 and 51.

With further reference to FIG. 5A, receiving member 30 is added to what is otherwise illustrated in FIG. 5 regarding the overall construction and geometry of bushing 42. As noted, each receiving member 30 and 31 is a substantially planar member and receiving member 30 is centered within its corresponding geometric plane 35. The same applies for receiving member 31 relative to its geometric plane 36. Geometric plane 35 and the longitudinal axis of through aperture 37 are substantially perpendicular to each other. This causes the longitudinal axis 56 of aperture 52 to be oriented so as to intersect geometric plane 35 with the same included angle 55. Similarly, end faces 50 and 51 are set at an inclined angle (same as angle 55) relative to geometric plane 35.

Referring now to FIG. 5B, a diagrammatic illustration is provided as a shift in alignment of apertures 37 and 38 and the corresponding shift in the location (and relationship) of the two bushings 42 and 43. What is clear is that the dividing line 59 between the substantially parallel faces 51 (of 42) and 51 (of 43) generally coincides with the longitudinal centerline 22a. As should be understood from this illustration, the amount of clearance between cooperating faces 51 and 51 is set in part by the amount of shift in alignment of apertures 37 and 38 and in part by the angle of incline of the two bushings 42 and 43. Arranging the end faces in this manner illustrated provides a suitable abutment surface for the hex head 27, hex nut 29, and any flat washers or lock washers which one may elect to use.

The outside diameter size and shape of body 49 and the inside diameter size and shape of through aperture 37 are such that there is a slip fit of the bushing 42 within the receiving member 30. This clearance is minimal so as to limit any wobble, yet still enable the bushing 42 to be able to be turned within the receiving member 30. The same is true for bushing 43, receiving member 31, and through aperture 38. This turning motion allows everything to be aligned (and still loose) prior to welding each bushing in position within its corresponding receiving member 30 and 31. There is essentially a single coaxial orientation for the bushing apertures 52 which permits the aligned insertion of bolt 24. The connection requirements for connection assembly 20 require the fastener 24 (bolt) to extend through and to be aligned with bushing 42, spacer 44, rod end 21, spacer 45 and bushing 43. The two spacers and the rod end are free floating so no axial alignment issues are presented with those components. However, each bushing 42 and 43 is ultimately fixed in position within its corresponding receiving member 30 and 31, respectively, preferably by welding. Therefore, a preliminary “check” of the entire connection assembly is made by loosely putting everything together and turning the bushings to find their bolt alignment orientation. At this point, each bushing 42 and 43 is welded into position within its corresponding receiving member 30 and 31, respectively.

If the receiving members 30 and 31 have experienced any of the misalignment or warpage issues discussed earlier, then without the benefit of bushings 42 and 43, some adjustment, rework, or realignment would be necessary. Bushings 42 and 43 enable a properly aligned connection without having to incur the time or expense of reworking the receiving members 30 and 31. Instead, by simply selecting the appropriate bushing 42 and 43, and by using the correct aperture offset, the fastener-receiving apertures 52 are easily aligned and provide an acceptable arrangement for connection assembly 20 for receiving rod end 21. The “appropriate” bushings means bushings which have an angle of incline which is selected based in part on the angle of the longitudinal centerline 22a and in part on the configuration and spacing of the receiving members 30 and 31. These variables are either known or can be determined. The data is then processed to decide on the aperture offset and the angle of incline for the bushings.

After the apertures 37 and 38 are machined into the receiving members 30 and 31, respectively, with the desired axial offset and after all other dimensional information is gathered and after the appropriate bushings are selected, the connection assembly is loosely assembled as a way to check and verify the final alignment. In order to do so, the bushings are turned within their corresponding apertures in order to properly align the corresponding bolt holes. There is only one coaxial orientation for each of the two bushings which results in a precise bolt hole alignment. Once this alignment is set, the bushings are secured in position within the receiving members, preferably by welding. The turning of the bushings so as to achieve bolt hole alignment is a type of “self-alignment” which is unique. The use of bushings with an inclined angle and the intentional offset of the apertures as tied to the angle of the longitudinal centerline 22a are also unique features.

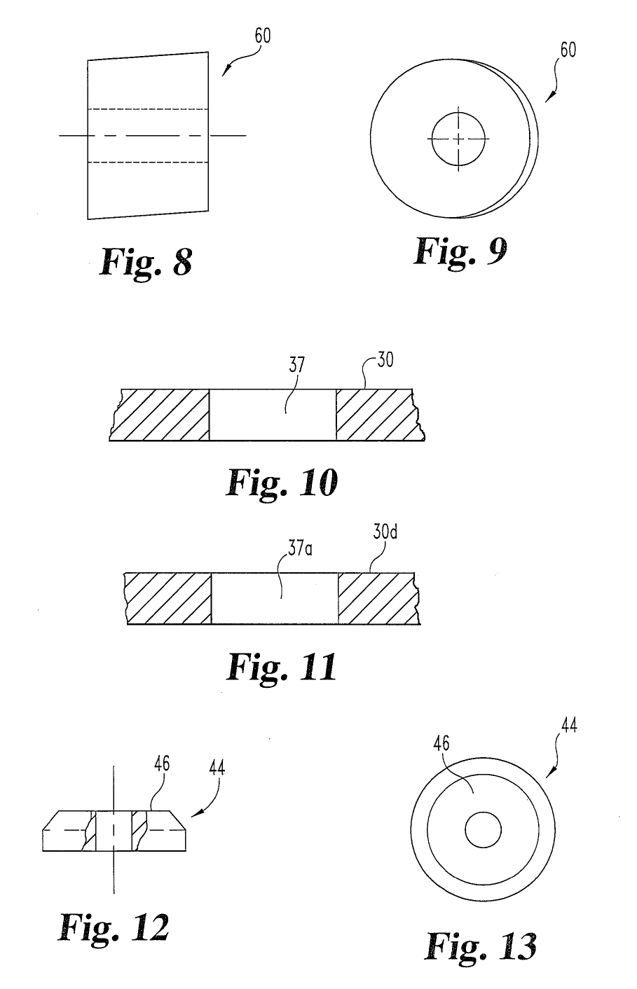

It is envisioned that a range of bushing options would be desirable, depending on the extent or magnitude of the angle of the longitudinal centerline 22a. The bushing options would also depend to some extent on the location and relationship of receiving members 30 and 31 and the location of apertures 37 and 38. When the rod angle to be accommodated is greater, a greater angle of incline 55 would be preferred. When the rod angle to be accommodated is smaller, a smaller angle of incline would be preferred. While it is anticipated that several “standard” bushings would be offered with a graduated range of angles of incline, only two such variations are illustrated herein. One option with a graduated range of angles would be to have “standard” bushings in three to five degree increments, beginning with a low or small angle of perhaps 2 degrees and extending on up to 45 degrees or perhaps slightly higher. It is also contemplated that the limited clearance of the various receiving bores and apertures for fastener 24 would provide some degree of adjustment for any misalignment and thus a single bushing might be suitable for a limited range of degrees of misalignment. Using slightly oversized apertures 37 and 38 would also introduce some added clearance. The two variations illustrated herein include bushings that are considered to be closer to the lower end point of the overall range and to a mid-range angle of incline. Bushing 42 which is illustrated in FIGS. 4-6 has the angle of incline set at between 18 degrees and 22 degrees (mid-range) and is specifically illustrated at 20 degrees. Bushing 60, which is illustrated in FIGS. 7-9, has the angle of incline set at between 2 degrees and 6 degrees and is specifically illustrated at 4 degrees. Bushing 60 is identical to bushing 42 except for the change in the angle of incline. All other geometric relationships and structural features are the same. The through apertures 37 and 38 for receiving members 30 and 31, respectively, are substantially perpendicular to the corresponding geometric planes 35 and 36. This relationship is not affected by the angle of incline. The 4 degree version of bushing 60 is illustrated in FIG. 11 using reference numbers 37a, 30d and 55a. As noted the angle of incline could be as high as approximately 45 degrees depending on the vehicle and its particular suspension configuration.

The construction and arrangement of the disclosed structures removes the need to measure or fit any parts prior to final assembly. There is no rework, no modifications, and no machining required prior to final assembly. The disclosed self-alignment capability of the rod end mounting bushings, as disclosed herein as part of the overall connection assembly, precludes the need to check any orientations or alignments prior to final assembly.

While the preferred embodiment of the invention has been illustrated and described in the drawings and foregoing description, the same is to be considered as illustrative and not restrictive in character, it being understood that all changes and modifications that come within the spirit of the invention are desired to be protected.

1. A rod end mounting bushing for use in a connection assembly, said rod end mounting bushing comprising:
a body having a longitudinal axis line extending through said body and opposite end faces, each end face having a defining geometric plane, each geometric plane being constructed and arranged at an angle of incline relative to said longitudinal axis line, said body defining a through aperture extending through said body from one end face to the opposite end face, said through aperture having a longitudinal axis line that is substantially perpendicular to at least one of said opposite end faces.

2. The rod end mounting bushing of claim 1 wherein the defining geometric planes are substantially parallel to each other.

3. The rod end mounting bushing of claim 2 wherein the angle of incline is between 18 degrees and 22 degrees.

4. The rod end mounting bushing of claim 2 wherein the angle of incline is between 2 degrees and 6 degrees.

5. The rod end mounting bushing of claim 1 wherein said body is generally cylindrical.

6. The rod end mounting bushing of claim 5 wherein the defining geometric planes are substantially parallel to each other.

7. The rod end mounting bushing of claim 6 wherein the angle of incline is between 18 degrees and 22 degrees.

8. The rod end mounting bushing of claim 6 wherein the angle of incline is between 2 degrees and 6 degrees.

9. A rod end mounting assembly for positioning a rod end between a pair of spaced-apart receiving members, each receiving member defining an aperture, said rod end mounting assembly comprising:
a pair of rod end mounting bushings, wherein each mounting bushing comprises:
a body having a longitudinal axis line extending through said body and opposite end faces, each end face having a defining geometric plane, each geometric plane being constructed and arranged at an angle of incline relative to said longitudinal axis line, said body defining a through aperture extending through said body from one end face to the opposite end face, said through aperture having a longitudinal axis line that is substantially perpendicular to at least one of said opposite end faces;
a fastener; and
wherein each rod end mounting bushing is received by the aperture of a corresponding receiving member and said fastener extends through said pair of rod end mounting bushings.

10. The rod end mounting assembly of claim 9 which further includes a pair of spacers.

11. The rod end mounting assembly of claim 10 wherein each spacer is constructed and arranged to be positioned between said rod end and an end face of a corresponding rod end mounting bushing.

12. The rod end mounting assembly of claim 9 wherein each receiving member lays within a geometric plane and each aperture is a generally cylindrical bore with an axis line which is generally perpendicular to said geometric plane.

13. The rod end mounting assembly of claim 12 wherein said body is generally cylindrical.

14. The rod end mounting assembly of claim 13 wherein the defining geometric planes are substantially parallel to each other.

15. The rod end mounting assembly of claim 14 wherein the angle of incline is between 18 degrees and 22 degrees.

16. The rod end mounting assembly of claim 14 wherein the angle of incline is between 2 degrees and 6 degrees.

17. The rod end mounting assembly of claim 9 wherein each rod end mounting bushing has a generally cylindrical body and each receiving aperture is a generally cylindrical bore and wherein said body and its corresponding bore are constructed and arranged for a slip fit.

18. A method of connecting a rod end to a support structure, said support structure including a pair of spaced-apart receiving members, the method of connecting comprising the following steps:
(a) creating a first receiving bore in a first receiving member;
(b) creating a second receiving bore in a second receiving member, wherein said first receiving bore having a first axis and said second receiving bore having a second axis which is offset from said first axis;
(c) providing a pair of mounting bushings, each mounting bushing having a generally cylindrical body with a longitudinal axis line, a pair of substantially parallel end faces, each end face having a substantially planar surface which is inclined relative to said longitudinal axis line, and a bore defined by the body, each bore having a longitudinal axis which is substantially perpendicular to the planar surface of each end face;
(d) providing a fastener;
(e) inserting each bushing into its corresponding receiving bore;
(f) turning at least one bushing within its corresponding receiving bore to generally obtain alignment of the two bushing bores;
(g) providing the rod end to be connected;
(h) positioning the rod end between the two bushings; and
(i) completing the assembly using the fastener by inserting the fastener through each bushing bore and through an aperture defined by the rod end.

19. The method of claim 18 including the added step of providing a pair of spacers.

20. The method of claim 19 including the added step of positioning each spacer within the assembly between the rod end and a corresponding one of the mounting bushings.

21. The method of claim 18 which further includes the step of creating said first receiving bore such that its axis is substantially perpendicular to a geometric plane containing said first receiving member.

22. The method of claim 21 which further includes the step of creating said second receiving bore such that its axis is substantially perpendicular to a geometric plane containing said second receiving member.

23. In combination:
a suspension rod;
a vehicle superstructure constructed and arranged with a pair of spaced-apart receiving members, each receiving member received within a corresponding geometric plane, wherein each receiving member defining an aperture having an axis which is generally perpendicular to the corresponding geometric plane and wherein one axis is offset from the other axis; and
a pair of rod end mounting bushings, wherein each mounting bushing comprises:
a body having a longitudinal axis line extending through said body and opposite end faces, each end face having a defining geometric plane, each geometric plane being constructed and arranged at an angle of incline relative to said longitudinal axis line, said body defining a through aperture extending through said body from one end face to the opposite end face, said through aperture having a longitudinal axis line that is substantially perpendicular to at least one of said opposite end faces;
a fastener; and
wherein each rod end mounting bushing is received by the aperture of a corresponding receiving member and said fastener extends through said pair of rod end mounting bushings.

24. The combination of claim 23 which further includes a pair of spacers, wherein one spacer is positioned between a mounting bushing and the rod end and another space is positioned between the other bushing and the rod end.

25. A method of varying the distance of separation between and end face of one mounting bushing and an end face of another mounting bushing of the claim 9 structure comprising the following step:
offsetting the axial centerline of one receiving member aperture from the axial centerline of the other receiving member aperture.
